(19) United States
(12) Patent Application Publication
(10) Pub. No.: US 2010/0156197 A1
(43) Pub. Date: Jun. 24, 2010

(54) APPARATUS AND METHOD FOR RECEIVING POWER WIRE-FREE WITH IN-LINE CONTACTS FROM A POWER PAD

(75) Inventor: Mitch Randall, Boulder, CO (US)

Correspondence Address: COCHRAN FREUND & YOUNG LLC, 2026 CARIBOU DR, SUITE 201, FORT COLLINS, CO, 80525, US

(73) Assignee: PURE ENERGY SOLUTIONS, INC., Boulder, CO (US)

(21) Appl. No.: 12/639,978

(22) Filed: Dec. 16, 2009

Related U.S. Application Data
(60) Provisional application No. 61/122,787, filed on Dec. 16, 2008.

(51) Int. Cl. H02J 5/00

(52) U.S. Cl. 307/145

(57) ABSTRACT

A linear contact array comprising three contacts is provided for wire-free electric power extraction from a power delivery pad for mobile electronic devices. The linear contact array is configured to assure effective contact for power transfer from the power delivery pad and the mobile electronic device anywhere on the power delivery surface for a range of angular orientations of the linear array in relation to the power delivery surface.

### CROSS-REFERENCE TO RELATED APPLICATIONS

This invention claims the benefit of U.S. provisional application No. 61/122,787, filed on Dec. 16, 2008.

### BACKGROUND OF THE INVENTION

### State of the Prior Art

The proliferation of portable or mobile, re-chargeable, battery powered, electronic, and/or electrically powered devices of many types and varieties is virtually boundless, due in large part to better and smaller rechargeable batteries, wireless communications and data transfer capabilities, and other capabilities and features that have made such electronic devices convenient and affordable. Consequently, many people have and use not just one, but a number of different electronic devices, for example, mobile phones, music players, notebook computers, laptop computers, personal digital assistants, cameras, GPS position locators, hearing aids, flash lights, and many others, all of which need to be recharged from time to time. Most of such devices can be recharged with electric power converted from standard, grid AC electric power, but manufacturers tend to make different electronic devices unique with respect to recharging power requirements, and they typically supply recharging power converters that are unique to the respective devices, complete with electric cords or plug-in units for plugging the power converters into standard, grid AC power outlets.

More recent developments include power supply pads with power supply surfaces on which a variety of such electronic devices equipped with conduction contacts can be positioned alone or along with others to receive recharging power in a wire-free manner, i.e., without wires or plugs between the power supply surfaces of the power delivery pads and the power receiver contacts on the mobile electronic or electrically powered devices. Examples of such wire-free recharging, including power supply pads for delivering power and conduction contacts for receiving power along with power rectifier and conditioning circuits, various configurations, retro-fit apparatus and methods, and other features are shown and described in U.S. Pat. No. 7,172,196, issued Feb. 6, 2007, U.S. patent application Ser. No. 11/672,010, filed Feb. 6, 2007 (Patent Application Publication No. US 2007/0194526 A1, published Aug. 23, 2007), U.S. patent application Ser. No. 11/682,309, filed Mar. 5, 2007 (Patent Application Publication No. US 2009/0072782 A1, published Mar. 19, 2009), and U.S. patent application Ser. No. 11/800,427, filed May 3, 2007 (Patent Application Publication No. US 2009/0098750 A1, published Apr. 16, 2009), all of which are incorporated herein by reference for all that they disclose.

An attribute of some of the wire-free conductive power delivery systems described in those and other publications includes combinations of power delivery pad configurations and power receiver contact configurations that ensure wire-free power transfer from the power pads to the electronic devices, regardless of the location or orientation at which the mobile electronic device with its power receiver contacts may be positioned on the power delivery pad. For example, for a power delivery pad with an array of square power surfaces, each one being opposite in polarity to each laterally adjacent power surface, a power receiver contact configuration or constellation comprising at least five contacts equally spaced in a circle (pentagon configuration) of appropriate size in relation to the square power surfaces, as illustrated in U.S. Pat. No. 7,172,196, can be sized and configured to ensure 100% probability of power transfer, regardless of location or orientation of the constellation of power receiver contacts on the power delivery pad. In another example, for a power delivery pad with an array of elongated, parallel power surfaces or strips, each one of which is opposite in polarity to each adjacent strip, a power receiver contact configuration or constellation comprising at least four contacts, three of which are at points of an equilateral triangle and the fourth of which is at the center of the equilateral triangle of appropriate size in relation to the elongated rectangular power surfaces, can ensure 100% probability of power transfer, regardless of location or orientation of the constellation of power receiver contacts on the power delivery pad, as illustrated in U.S. patent application Ser. No. 11/672,010, filed Feb. 6, 2007 (Patent Application Publication No. US 2007/0194526 A1, published Aug. 23, 2007), U.S. patent application Ser. No. 11/682,309, filed Mar. 5, 2007 (Patent Application Publication No. US 2009/0072782 A1, published Mar. 19, 2009), and U.S. patent application Ser. No. 11/800,427, filed May 3, 2007 (Patent Application Publication No. US 2009/0098750 A1, published Apr. 16, 2009). Other examples may include a contact constellation comprising four contacts at the corners of a square and a fifth contact in the center of the square or a contact constellation comprising five contacts at the corners of an equilateral pentagon and a sixth contact at the center of the pentagon, as also illustrated in U.S. patent application Ser. No. 11/672,010, filed Feb. 6, 2007 (Patent Application Publication No. US 2007/0194526 A1, published Aug. 23, 2007).

The foregoing examples of related art and limitations are intended to be illustrative, but not exclusive or exhaustive of the subject matter. Other aspects and limitations of the related art will become apparent to those skilled in the art upon a reading of the specification and a study of the drawings.

### BRIEF DESCRIPTION OF THE DRAWINGS

The accompanying drawings, which are incorporated herein and form a part of the specification, illustrate some, but not the only or exclusive, example embodiments and/or features that can implement or explain the invention. It is intended that the embodiments and figures disclosed herein are to be considered illustrative rather than limiting.

In the drawings:

FIG. 1 is a perspective view of an example small mobile electronic device equipped with a linear, three contact array for receiving power in a wire-free manner poised above a power delivery pad;

FIG. 2 is a perspective view of the example small mobile electronic device equipped with the linear three contract array parked on the power delivery pad for receiving power from the power delivery pad;

FIG. 3 is a diagrammatic plan view of a part of the power delivery surface of the power delivery pad with various example cases of the example linear, three contact array oriented at different angles and positioned at different locations on the power delivery surface;

FIG. 4 is an example function block diagram of an example mobile electronic device with the example three contact array positioned to derive power from a power delivery pad;

FIG. 5 is an example bridge rectifier circuit for the example three contact power receiver assembly equipped with a linear array or constellation of three contacts;

FIG. 6 is a diagrammatic illustration of a four contact configuration for a power receiver assembly for comparison to the three contact, linear configuration;

FIG. 7 is a front elevation view of the example small mobile electronic device that can be equipped with a linear array of three power receiver contacts;

FIG. 8 is a back elevation view of the example small mobile electronic device equipped with the example linear, three contact array;

FIG. 9 is a diagrammatic view of example angular orientations for a mobile electronic device equipped with the example linear, three contact array, which can guarantee power transfer, shown superimposed over a top plan view of the example power delivery pad;

FIG. 10 is a composite view of example small, mobile electronic devices at various possible orientations for receiving power; and

FIG. 11 is a partial cross-sectional view, taken along section line 11-11 in FIG. 8, showing an example mounting for three example linear array contacts.

### DETAILED DESCRIPTION OF EXAMPLE IMPLEMENTATIONS

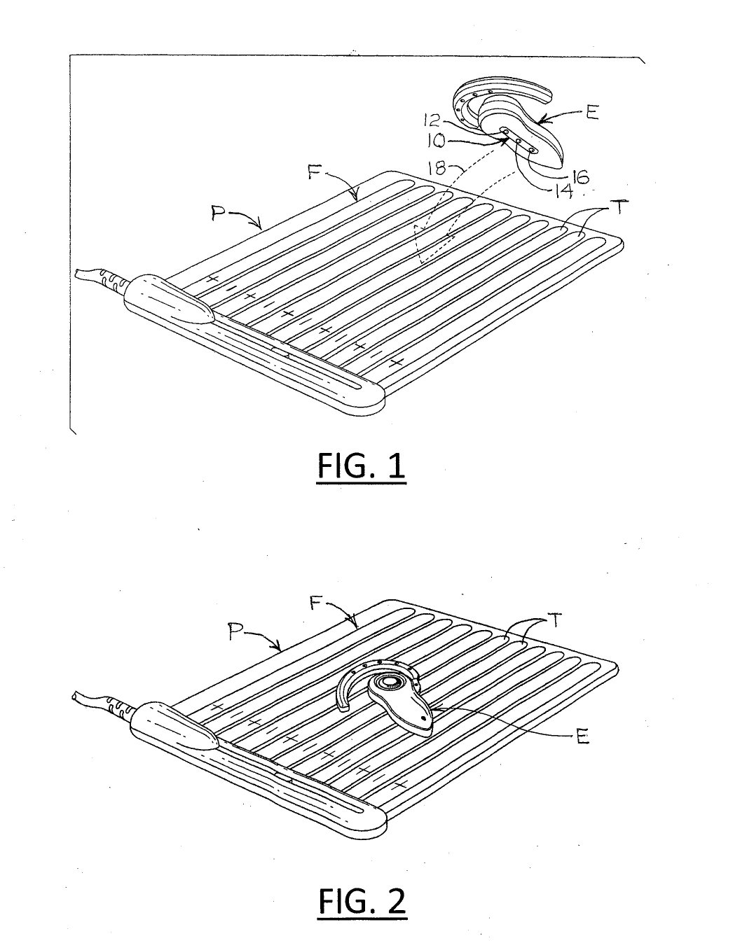

An example, space-limited, power receiver assembly 10, with three power receiver contacts 12, 14, 16, is illustrated in FIG. 1, mounted, for example, on the bottom or back side of a portable or mobile electronic and/or electrically powered device E, which is shown poised above a power delivery pad P as it may appear just before being placed onto the power delivery surface F to receive charging and/or operating power from the power delivery pad P. The example power receiver assembly 10 shown in FIG. 1, with three power receiver contacts 12, 14, 16 in linear alignment with each on the bottom or back side of the electronic device D, is one example implementation of the invention, but recognizing that the invention recited in the claims below can also be implemented in myriad other ways, once the principles are understood from the description and examples herein.

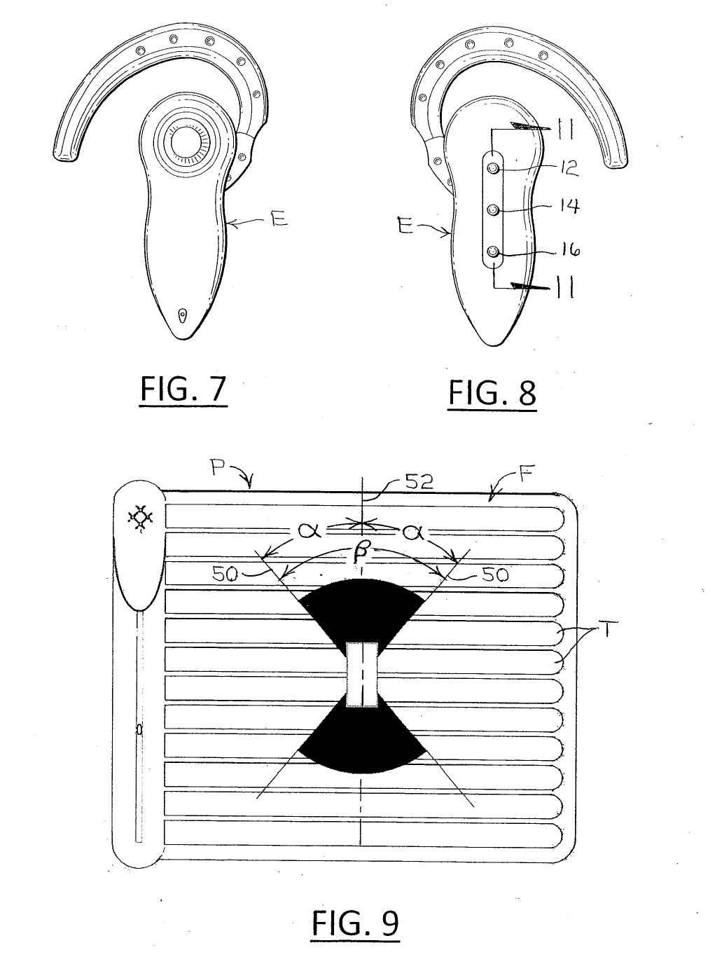

The mobile electronic device E depicted in FIG. 1 and in FIGS. 2, 7, 8, and 10 is a generic representation of any number and variety of mobile electronic devices available commercially or otherwise, such as BlueTooth headsets, hearing aids, cell phones, personal digital assistants, cameras, computers, games, toys, calculators, global positioning satellite (GPS) locating devices, recording devices, monitoring devices, medical equipment, test equipment, notebook and laptop computers, tools, and many others. Generally, such mobile electronic and/or electrically powered devices are small enough and portable enough to be carried or worn easily by a person and are typically powered by rechargeable batteries that have to be recharged intermittently or periodically. The mobile electronic device E illustrated in FIG. 1 is typical of small electronic devices, for example, BlueTooth headsets for phones, music players, or the like, or for example hearing aids, because at least some of such devices are small enough to have limited surface area for power receiving contacts 12, 14, 16, which is an application for which this invention is particularly suitable. However, it is also applicable to other larger and differently configured mobile electronic and/or electrically powered devices as well. The power receiver assembly 10 with the contacts 12, 14, 16 can be manufactured as part of mobile electronic and/or electrically powered device E, or it can be part of a retrofit assembly that can be added to a mobile electronic and/or electrically powered device E.

To avoid cumbersome repetition, portable or mobile electronic and/or electrically powered devices are hereinafter called simply mobile electronic device E. Also, for purposes of simplicity, up, down, right, top, bottom, front, and back may be used in the description herein as related to the views in the drawings and their orientations on the paper or as otherwise explained, but with the understanding that the implementation of the apparatus and assemblies described or claimed herein are not limited to those directional descriptions and can be oriented in any direction, unless otherwise specified.

The example power delivery pad P shown in FIG. 1 and in other figures herein is not, itself, part of this invention, but it is illustrated to make it easier to understand the power receiver assembly 10 and the configuration of the power receiver assembly 10, including the linear array or constellation comprising the three contacts 12, 14, 16, in relation to sizes and configurations of particular power delivery pads P with which the power receiver assembly 10 may be used to advantage. In general, a mobile electronic device E fitted or retrofitted with the power receiver assembly 10 can be placed on the power delivery pad P, as indicated by the arrow 18 in FIG. 1 and illustrated for example in FIG. 2, to receive power in a wire-free manner, i.e., without wire or plug connections between the power delivery pad P and the power receiver assembly 10. Each of the conductive power delivery strips T that form the conductive power delivery surface F of the power delivery pad P is charged or biased by a power supply circuit or adapter 102 (see FIG. 4—not visible in FIGS. 1 and 2) at an opposite polarity or different voltage level from the adjacent power delivery strips T, as indicated, for example, by the positive (+) and negative (−) symbols on the power delivery strips T in FIG. 2.

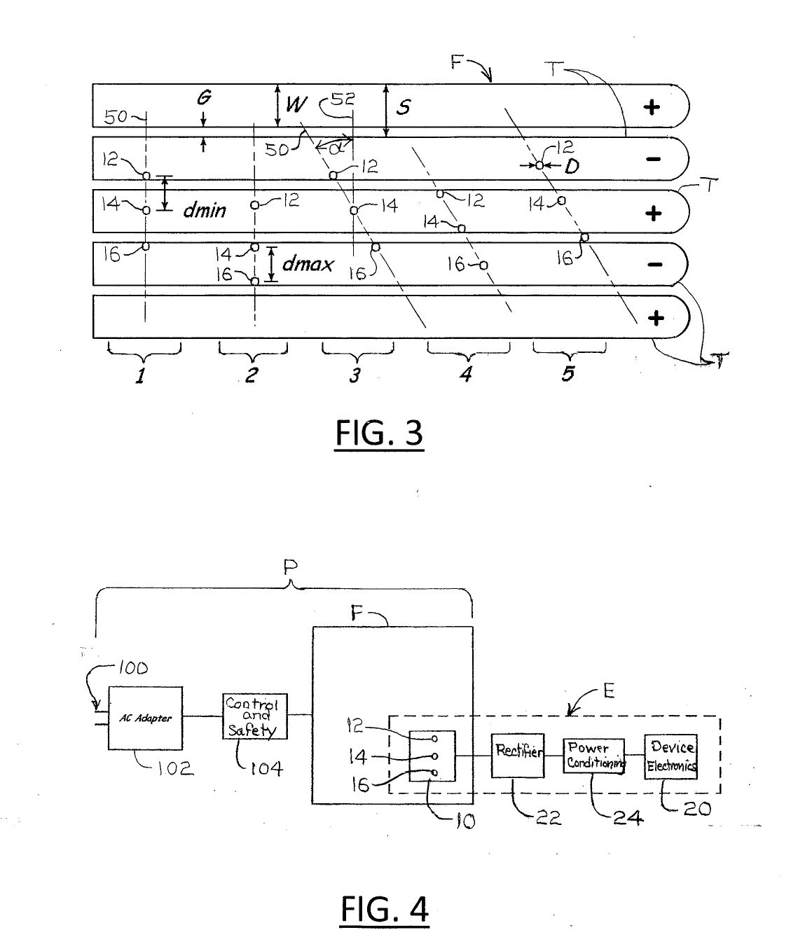

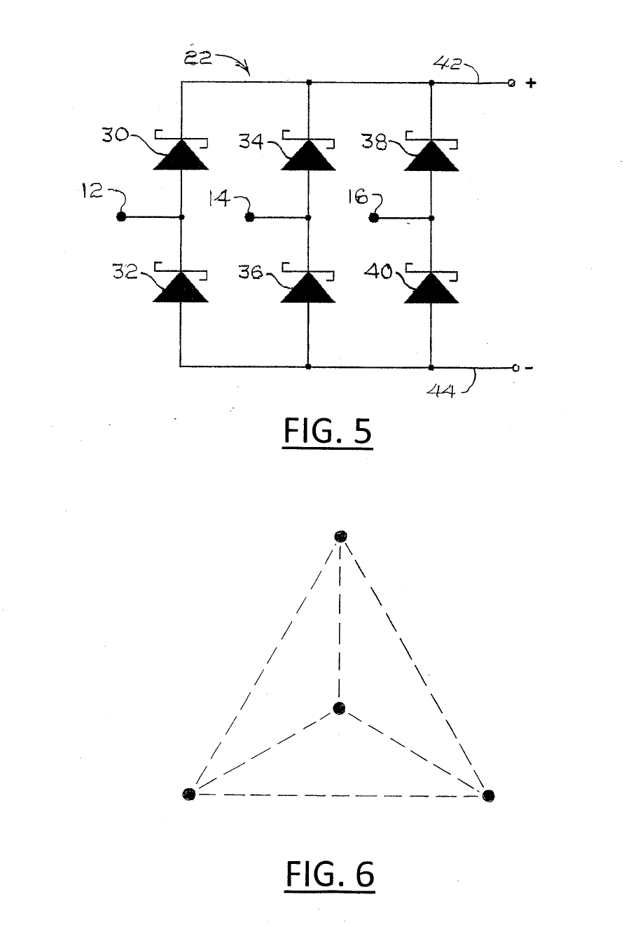

The power from the power delivery surface F of the power delivery pad P is received by the three contacts 12, 14, 16 of the power receiver assembly 10, when the electronically powered device 10 is placed on the power delivery pad 10, as illustrated in FIG. 2, and at least one of the three contacts 12, 14, 16 is positioned in electrical contact with a positively charged or biased (+) strip T and at least one other of the contacts 12, 14, 16 is positioned in electrical contact with a negatively charged or biased (−) strip T as illustrated for example in FIG. 3. The power received by the power receiver assembly 10 is rectified and conditioned, as indicated in the function block diagram in FIG. 4, to be usable by the electronics 20 of the particular mobile electronic device E. An example rectifier circuit 22 that is appropriate for the three contacts 12, 14, 16 is shown in FIG. 5 and described below. An appropriate power conditioning circuit 24 will depend on the power characteristics for which the electronics 20 of the electronically powered device E are designed and built. Such conditioning is not part of this invention, but may include, for example, voltage converter or regulator, filters, safety circuits, spark arrestor, power pad authentication or identification, or other features, including, but not limited those described in, for example, U.S. patent application Ser. No. 11/672,010, filed Feb. 6, 2007 (Patent Application Publication No. US 2007/0194526 A1, published Aug. 23, 2007), U.S. patent application Ser. No. 11/682,309, filed Mar. 5, 2007 (Patent Application Publication No. US 2009/0072782 A1, published Mar. 19, 2009), and U.S. patent application Ser. No. 11/800,427, filed May 3, 2007 (Patent Application Publication No. US 2009/0098750 A1, published Apr. 16, 2009), as well as in, for example, U.S. patent application Ser. No. 12/251,428, filed on Oct. 14, 2008, and U.S. patent application Ser. No. 12/363,509, filed on Jan. 30, 2009, which are also incorporated herein by reference. Such rectifier circuit 22 and/or power conditioning circuit or circuits 24 can be part of the power receiver assembly 10 or part of the electronic circuitry 20 of the mobile electronic device E.

An example rectifier circuit 22 is shown by the schematic diagram in FIG. 5 for rectifying the voltages that are obtained from the contacts 12, 14, 16, when they are in contact with at least one positive (+) strip T and at least one negative (−) strip T of the power delivery surface F, as shown, for example, by the contact orientations 1-5 in FIG. 3, to ensure that the proper polarity DC power is provided to the electronics 20 and/or power conditioning circuit 24. As shown in FIG. 4, there are three sets of series connected Schottky diodes, one pair for each of the three contacts 12, 14, 16. The series connected Schottky diode pair 30, 32, the series connected Schottky diode pair 34, 36, and the series connected Schottky diode pair 38, 40 are connected in parallel to a positive (+) power line 42 and a negative (−) power line 44. Specifically, in the example shown in FIG. 5, the cathodes of the Schottky diodes 30, 34, 38 are connected in parallel to the positive power line 42, and the anodes of the Schottky diodes 32, 36, 40 are connected in parallel to the negative (−) power line 44. The anode of diode 30 and the cathode of the diode 32 are connected to the contact 12. Similarly, the anode of the diode 34 and the cathode of the diode 36 are connected to the contact 14, and the anode of the diode 38 and the cathode of the diode 40 are connected to the contact 16. Consequently, regardless of which of the contacts 12, 14, 16 is in contact with a positive (+) conductive strip T of the power delivery surface F and which of the contacts 12, 14, 16 is in contact with a negative (−) conductive strip T, the line 42 will always be positive (+) and the line 44 will always be negative (−). The output power on lines 42, 44 is then filtered and set to the proper voltage in the power conditioning circuit 24 for use by the electronics 20 of the mobile electronic device E (FIG. 4). Although Schottky diodes are shown in the example rectifier circuit 22 in FIG. 5, any fast acting diodes can be used.

As mentioned above, there are a number of contact patterns or constellations that, in combination with certain power delivery pad configurations and sizes, can provide 100 percent assurance that at least one contact will touch a positive (+) surface and at least one other contact will touch a negative (−) surface of the power delivery pad, regardless of the location or orientation at which the mobile electronic device is placed on the power delivery surface. For example, for a power delivery pad P with a power delivery surface F comprising a plurality of elongated, parallel charged strips T, as shown in FIGS. 1-3, a power receiver assembly comprising as few as four contacts in a pattern or constellation, wherein three of the contacts are positioned to form the points of an equilateral triangle and the fourth contact is positioned in the middle of the equilateral triangle, as illustrated in FIG. 6, can provide 100 percent assurance of power transfer, regardless of where the mobile electronic device is positioned on the power delivery surface F and at any angular rotation orientation of the mobile electronic device on the power delivery surface F. This type of pattern or constellation comprising four contacts as shown in FIG. 6 is sometimes called a tetrahedron pattern because it is reminiscent of the appearance of the points or vertices of a tetrahedron in top plan view. For a variety of reasons, including, but not limited to, the simplicity of the structure of elongated, conductive strips T forming the power delivery surface F of the power delivery pad P, this tetrahedron pattern of four contacts to provide 100 percent assurance of power transfer has become a popular pattern for wire-free recharging systems for mobile electronic devices.

However, some mobile electronic devices are quite small and do not have a convenient, sufficiently wide surface to accommodate a tetrahedron or other two-dimensional constellation pattern as needed for 100 percent assurance of power to transfer from the power delivery surface F configuration as illustrated in FIGS. 1-3, at any position and orientation of the mobile electronic device on the power delivery surface F. For example, the small mobile electronic device E shown in FIGS. 1, 2, 7, 8, and 10 (which may be representative of a Blue Tooth headset or ear piece for a hands-free telephone or cell phone, or of a hearing aid, or any other such small size mobile electronic device) does not have a convenient surface that is large enough to accommodate a tetrahedron or other two-dimensional constellation of contacts. Therefore, while a power delivery pad P with the popular elongated contact strip T configuration shown in FIGS. 1-3 may be available, a user might not be able to use it for recharging such small mobile electronic devices E illustrated in FIG. 6.

To over come this problem, the small mobile electronic device E with limited space, especially limited width, for a contact array or constellation, can be equipped with a linear pattern or constellation comprising at least three contacts 12, 14, 16 of appropriate size and spacing, as explained below, to assure 100 percent assurance of power transfer from a power delivery surface F of a power delivery pad P illustrated for example in FIGS. 1-3, but in a narrower range of angular or rotational orientation than 360 degrees. Specifically, as described in more detail below, the linear pattern or constellation comprising at least three contacts 12, 14, 16, as shown in FIGS. 1, 8, and 10, can be made to provide 100 percent assurance of power transfer from the power delivery surface F in a very useful angular range a of as much as 41 degrees rotation of the major (longitudinal) axis 50 of the linear array or constellation of contacts 12, 14, 16 either direction from a line 52 that is perpendicular to the elongated or longitudinal direction of the conductive strips T of the power delivery surface F, as illustrated in FIG. 9.

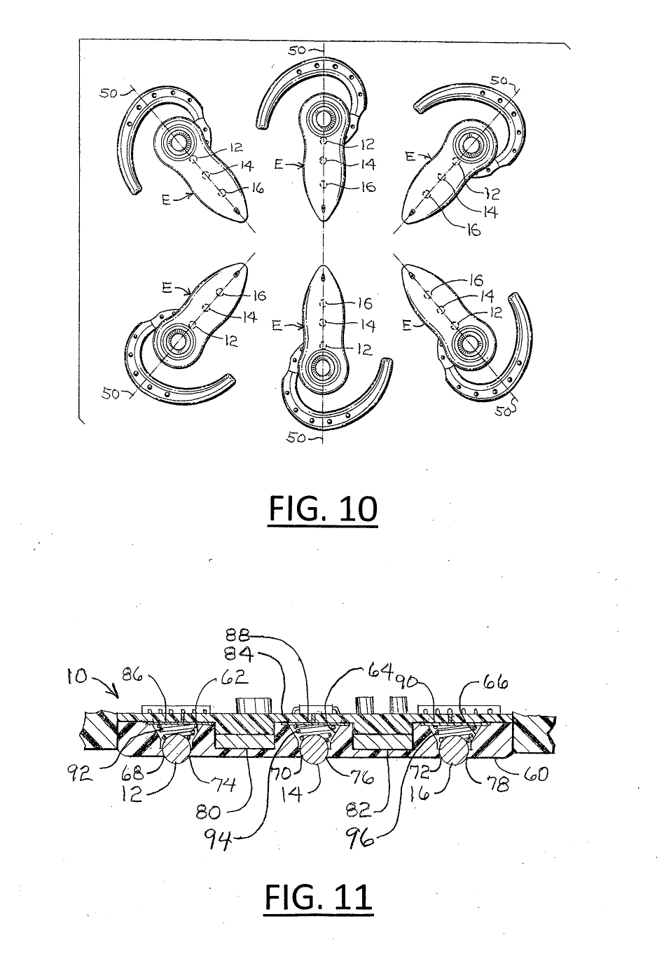

Consequently, while this linear pattern or constellation comprising three contacts 12, 14, 16 cannot provide 100 percent assurance of power transfer in a full 360 degrees of angular rotation or orientation on the power delivery surface F, it can provide 100 percent assurance of power transfer with a very practical and useful angular rotation range of at least 82 degrees (i.e., 41 degrees either direction from the perpendicular line 52), and twice that, i.e., 164 degrees, if the inverse (where the device E is rotated around 180 degrees, as shown in FIG. 10) is also considered. This angular orientation range, in which power transfer is assured, is supported and effective, regardless of the lateral position or translation (i.e., left, right, forward, or backward) of the mobile electronic device E on the power delivery surface F. Therefore, with even just a minimal amount of care and attention to angular orientation while placing the mobile electronic device E on the power delivery surface F, just about any person can easily position the mobile electronic device E to receive power from the power delivery pad P.

Referring again primarily to FIG. 3, five cases or orientations 1-5 of the three collinear contacts 12, 14, 16 are shown for analysis and explanation. In case 1, the three contacts 12, 14, 16 are aligned perpendicularly to the conductive strips T. As explained above, it is assumed that the conductive strips T are charged or energized with two different potentials indicated as positive (+) and negative (−) in FIG. 3. The configuration is such that adjacent conductive strips T are of equal width W, separated by a non-conductive gap G, and of opposite polarity +/−. It is assumed that for any linear, relative configuration of the three contact points 12, 14, 16, their absolute position will be arbitrary with relation to the conductive contact strips T. It is also assumed that the three collinear contact points 12, 14, 16 are also equally spaced and that the contact diameter D of the contacts 12, 14, 16 are equal. For the purpose of this discussion, a zero angle between the major axis 50 of the three collinear contact points 12, 14, 16 and the contact strips T is defined as that angle α where the axis 50 is at right angles to the strips T. As such, the angular orientation of the axis 50, as shown in case 1 in FIG. 3, is considered to be zero degrees.

It is known a priori that the proposed linear pattern of contact points 12, 14, 16 cannot retrieve power from the power delivery surface F at all angles α, because, for example, when the angle α is 90 degrees, the three contact points 12, 14, 16 would all be subject to the same polarity, which is insufficient or incapable of retrieving power. In order for such a collinear configuration of three contact points 12, 14, 16 to be able to derive power from placement upon the given set of conductive contact strips T, at least one of the contact points 12, 14, 16 must be on a positive (+) strip T, and at least one other of the contact points 12, 14, 16 must be on a negative (−) strip T, as explained above. The rectifier circuit 22 comprising the six diodes 30, 32, 34, 36, 38, 40 (FIG. 5) will then ensure that, regardless of which contacts are in contact with which of the two polarities, an output of the bridge rectifier 22, e.g., on the positive and negative lines 42, 44 (FIG. 5) will be of a fixed polarity for use in delivering usable power.

Case 1 in FIG. 3 shows a limiting case in which the angular orientation α of the axis 50 is zero degrees, and the position is such that the two outer contact points 12, 16 are on negative (−) conductive contact strips T, and the middle contact 14 is on a positive (+) conductive contact strip T. If the minimum distance dₘᵢₙ between adjacent contacts was any smaller than shown, neither of the outer contacts 12, 16 would be sufficiently connected electrically to a negative (−) strip T to transfer power, i.e., would be in the non-conductive gaps G between adjacent conductive strips T, thus would prevent operation in that position.

Case 2 of FIG. 3 shows a second limiting case defining the largest distance dₘₐₓ between adjacent contacts was any greater than shown, two of the contacts 14, 16 would not connect sufficiently to the conductive contact strips T to receiver power, i.e., would be in the non-conductive gaps G, thus preventing operation in that position.

Although any spacing of the contacts 12, 14, 16 between dₘᵢₙ and dₘₐₓ would work for zero degree operation, the case 2 describing the maximum contact point spacing is of greatest interest, because it is desired that the contact points work to transfer power for angles α other than zero degrees in order to provide some angular orientation tolerance for positioning the device E on the power delivery surface F and still have 100 percent assurance of power transfer within that tolerance. The angle α from zero is greatest when the contact spacing is greatest. The limiting case is shown in case 3 in FIG. 3.

Specifically, case 3 shows the configuration where beyond the angle α shown, the outer contacts 12, 16 would not make sufficient contact with the conductive contact strips T to transfer power. The spacing dₘₐₓ between adjacent contacts is shown to be:

dₘₐₓ=W−D, Equation (1)

where W is the width of the contact strips T and D is the diameter of the contact point. The angle of α of operation from zero (perpendicular) is shown to be the angle:

α=A COS((W+2G+D)/(2×dₘₐₓ)). Equation (2)

Other spacings d between dₘᵢₙ and dₘₐₓ could also be chosen and might be useful or even necessary, for example, in some situations where space or room on the mobile electronic device E for the linear array of the three contacts is too small for spacing the contacts 12, 14, 16 at dₘₐₓ. However, according to equation (2), any such other spacings would result in a smaller angular range a from the zero angle or perpendicular 52 in which power transfer or delivery from the power delivery surface F to the mobile electronic device E is assured at all lateral positions of the contact 12, 14, 16 constellation on the power delivery surface F.

Cases 4 and 5 of FIG. 3 show the worst-case angle of case 3 (maximum angular tolerance for assured power transfer) translated to two other interesting lateral positions on the power delivery surface F. The purpose of showing these two cases is to demonstrate visually how the three contact points 12, 14, 16 achieve power transfer at all lateral positions within that angular orientation tolerance.

The parameters W, S, G, and D are chosen, in general, based on other parameters not necessarily specific to the three collinear contact point 12, 14, 16 configuration or spacing. For example, they may be chosen as optimal for the four contact tetrahedron constellation shown in FIG. 6, so use of the collinear three contact 12, 14, 16 configuration in such circumstance, e.g., on a power delivery surface F configured for a tetrahedron contact constellation may necessitate adaptation of the collinear three contact configuration to such a given power delivery surface F configuration. The equations (1) and (2) above, therefore, relate the inter-point spacing d of the collinear, three contact 12, 14, 16 constellation to provide a way of extracting power from such a given power delivery surface F for any lateral position and over the greatest, or at least a possible desired, range of orientation angle α.

As mentioned above, applying the equation (2) with dₘₐₓ=W−D according to equation (1) yields a maximum orientation angle α of +/−41 degrees from perpendicular 52 for the major constellation axis 50, as shown in FIG. 9. A lesser angular range a can be determined by substituting a smaller contact 12, 14, 16 spacing distance d for the parameter dₘₐₓ in equation (2). Alternatively, such a different spacing distance d can be determined for a given lesser angle α by choosing a lesser angle α for use in the equation (2) and solving for the lesser spacing distance d, assuming the other parameters are fixed by the particular power delivery surface F being considered or used. For example, while +/−41 degrees is the largest angle α, a lesser angle α of 30 degrees or 20 degrees in which power transfer is assured could still be feasible and beneficial. Therefore, any spacing distance d between the contacts 12, 14, 16 that results in an angle α between 20 degrees and 41 degrees (20°≦α≦41°) or between 30 degrees and 41 degrees (30°≦α≦41°) or even between zero degrees and 41 degrees (0°≦α≦41°) according to formula (2) may be useful for a particular situation or application. In other words, for an angle α=41° according to formula (2), d=dₘₐₓ, and for an angle α<41°, d<dₘₐₓ. Therefore, in general, a 100 percent probability of having at least one of the three contacts 12, 14, 16 in the linear array touch a contact strip T of one polarity and another of the three contacts 12, 14, 16 touch a contact of opposite polarity when the entire linear array is positioned within an angular orientation tolerance β between +α and −α (i.e. β=2α as shown in FIG. 9) anywhere on the power delivery surface F when:

α=A COS((W+2G+D)/(2×d)), dₘᵢₙ≦d≦dₘₐₓ Equation (3)

where dₘᵢₙ=G+(W+D)/2 and dₘₐₓ=W−D.

A further example of the range of angular orientations is shown in FIG. 10. The top row of three mobile electronic device E images demonstrates −41 degrees (left image), 0 degrees (middle image), and +41 degrees (right image). The left image of the top row corresponds to the fartherest to the left a device E equipped with the three collinear contacts 12, 14, 16 can be oriented and still guarantee power transfer. The right image of the top row corresponds to the fartherest to the right the device E can be oriented and still guarantee power transfer. Every angle between those two extremes will also support power transfer. The bottom row of FIG. 10 demonstrates the range of possible power transfer orientations, but with the device rotated around 180 degrees.

The contacts 12, 14, 16 can be any of myriad shapes, configurations, and sizes. In the example power receiver assembly 10 illustrated in FIGS. 1 and 8, the contacts 12, 14, 16 are shown as metal balls mounted in cavities 62, 64, 66 of a housing 60 of the power receiver assembly 10 as best seen in FIG. 11. The contact balls 12, 14, 16 are captured in the cavities 62, 64, 66 by lips at the rims 68, 70, 72 around the holes 74, 76, 78 that open from the cavities 62, 64, 66, respectively, and they are biased to partially protrude through the holes 74, 76, 78. Magnets 80, 82 can be used to help secure the device E to the power delivery surface 66 during power transfer. A circuit board 84 can be used to mount the rectifier and/or power conditioning circuits in the housing 60 and to hold the magnets 80, 82, electrically conductive contact plates 86, 88, 90, and springs 92, 94, 96 in place. Electricity derived from contact of the contact balls 12, 14, 16 on the conductive contact strips T of the power delivery pad P (FIGS. 1-3) is conducted by the metal contact balls 12, 14, 16, springs 92, 94, 96, and contact plates 86, 88, 90 to the circuit board components (FIG. 11). Therefore, when the mobile electronic device E is positioned anywhere on the power delivery surface F within the angular orientation tolerances described above, AC power from a wall plug 100 shown in FIG. 4 is converted by an AC adapter 102 to DC power (not limited to wall power), which is conditioned and controlled to a desired level by a control circuit 104, and applied to the contact strips T. The power delivery pad P may also have safety circuits, load sensors, sleep mode, authenticating, or other circuits or functions as described, for example, in above-cited references incorporated herein, and applied to the contact strips T (FIGS. 1-3). The power receiver assembly 10 of the mobile electronic device E receives the power from the power delivery pad P as described above, rectifies it, conditions it, and provides it to the electronics or load of the mobile electronic device as explained above.

While the linear, three contact array described above is particularly suitable for small, mobile electronic devices with limited surface area that cannot accommodate larger or different shaped contact configurations or constellations, as explained above, it can also be used on any other mobile electronic devices when 100 percent-assurance of power transfer is not necessary for a full 360 degrees of possible angular orientation.

While a number of example aspects and implementations have been discussed above, those of skill in the art will recognize certain modifications, permutations, additions, and subcombinations thereof. It is therefore intended that the following appended claims and claims thereafter introduced are interpreted to include all such modifications, permutations, additions, and subcombinations as are within their true spirit and scope.

The words “comprise,” “comprises,” “comprising,” “composed,” “composes,” “composing,” “include,” “including,” and “includes” when used in this specification, including the claims, are intended to specify the presence of stated features, integers, components, or steps, but they do not preclude the presence or addition of one or more other features, integers, components, steps, or groups thereof. Also the words, “maximize” and “minimize” as used herein include increasing toward or approaching a maximum and reducing toward or approaching a minimum, respectively, even if not all the way to an absolute possible maximum or to an absolute possible minimum.

What is claimed is:

1. A method of extracting power from a power delivery surface comprised of a plurality of rectangular, parallel contact strips, wherein adjacent contact strips are separated from each other by a non-conductive gap and energized with opposite polarities, comprising the acts of:
arranging at least three electrically conductive contacts, which have contact surfaces smaller than the non-conductive gap, into a linear contact array;
placing the linear contact array on the power delivery surface in a manner that at least one of the contacts touches a contact strip of one polarity and at least one other of the contacts touches a contact strip of opposite polarity; and
conducting electricity from the contact strips, through the contacts that touch the contact strips, to an electronic circuit that provides a load.

2. The method of claim 1, including having the three contacts in the linear contact array spaced to provide 100 percent probability that placing the entire linear contact array within an angular tolerance in relation to the contact strips anywhere on the power delivery surface causes at least one of the contacts to touch a contact strip of one polarity and at least another of the contacts to touch a contact strip of opposite polarity.

3. The method of claim 2, including having the angular tolerance equal to two times an angle from a line perpendicular to the rectangular contact strips, where
α=A COS((W+2G+D)/(2×d)), dₘᵢₙ≦d≦dₘₐₓ
where dₘᵢₙ=G+(W+D)/2, dₘₐₓ=W−D, W is the width of the contact strips, D is the diameter of the contact surface of a contact in the linear array, and G is the width of the non-conductive gap.

4. The method of claim 2, wherein the angular tolerance is between zero degrees and 41 degrees with respect to a line perpendicular to the rectangular contact strips.

5. The method of claim 2, wherein the angular tolerance including both directions from a line perpendicular to the rectangular contact strips is between zero degrees and 82 degrees.

6. The method of claim 2, wherein the angular tolerance including both directions from a line perpendicular to the rectangular contact strips is in a range of 40 to 82 degrees.

7. The method of claim 2, wherein the angular tolerance including both directions from a line perpendicular to the rectangular contact strips is in a range of 60 to 82 degrees.

8. The method of claim 2, wherein the angular tolerance including both directions from a line perpendicular to the rectangular contact strips is 82 degrees.

9. The method of claim 2, wherein the angular tolerance including both directions from a line perpendicular to the rectangular contact strips is in a range of zero to 60 degrees.

10. The method of claim 2, wherein the angular tolerance including both directions from a line perpendicular to the rectangular contact strips is in a range of zero to 40 degrees.

11. Power receiver apparatus for extracting electric power from a power delivery surface that has a plurality of rectangular, parallel, contact strips, wherein adjacent contact strips are separated from each other by a non-conductive gap and energized with opposite polarities, comprising:
at least three electrically conductive contacts arranged in a linear contact array, wherein each of the three contacts has a contact surface that is smaller than the gap and is spaced a distance from the adjacent contact that provides 100 percent probability of at least one of the three contacts touching a contact strip of the opposite polarity with the linear array of the three contacts positioned at any lateral position on the power delivery surface and oriented within an angular tolerance range of zero to 41 degrees either direction from a line that is perpendicular to the direction of a major axis of the rectangular contact strips.

12. The apparatus of claim 11, wherein the angular tolerance range includes an angle α either direction from the perpendicular line, where
α=A COS((W+2G+D)/(2×d)), dₘᵢₙ≦d≦dₘₐₓ
where dₘᵢₙ=G+(W+D)/2, dₘₐₓ=W−D, W is the width of the contact strips in the direction of the perpendicular line, D is the diameter of the contact surface of the contact in the linear array, and G is the width of the non-conductive gap.

13. The apparatus of claim 11, wherein the angular tolerance range either direction from the perpendicular line is in a range of 20 to 41 degrees.

14. The apparatus of claim 11, wherein the angular tolerance range either direction from the perpendicular line is in a range of 30 to 41 degrees.

15. The apparatus of claim 11, wherein the angular tolerance range either direction from the perpendicular line is in a range of zero to 30 degrees.

16. The apparatus of claim 11, wherein the angular tolerance range either direction from the perpendicular line is in a range of zero to 20 degrees.

17. Power receiver apparatus for extracting electric power from a power delivery surface having a plurality of oppositely charged, electrically conductive contact surfaces separated by non-conductive gaps, comprising:
at least three electrically conductive contacts aligned in a linear array, each of which contacts has a contact surface that is smaller than the gap, and wherein each of the contacts is spaced a distance from adjacent contacts that provides 100 percent probability of at least one of the contacts touching a conductive contact surface on the power delivery surface of one polarity and at least another of the contacts touching a conductive contact surface of opposite polarity with the linear array of contacts positioned at any lateral position on the power delivery surface and oriented within an angular tolerance range of zero to 82 degrees.
